(19) United States
(12) Patent Application Publication
(10) Pub. No.: US 2011/0078013 A1
(43) Pub. Date: Mar. 31, 2011

(54) RATE-BASED AUCTION-FORMAT ONLINE ADVERTISEMENT MANAGEMENT

(75) Inventors: Wendell Craig Baker, Palo Alto, CA (US); Joaquin Arturo Delgado Rodriguez, Santa Clara, CA (US)

(73) Assignee: Yahoo! Inc., Sunnyvale, CA (US)

(21) Appl. No.: 12/569,210

(22) Filed: Sep. 29, 2009

(51) Int. Cl. G06Q 30/00; G06Q 10/00

(52) U.S. Cl. 705/14.42; 705/14.52; 705/14.71

(57) ABSTRACT

Methods and systems are provided for use in connection with an online advertising exchange. Methods are provided in which an auction format is utilized. However, generally, selection and pricing is rate-based and based on near-term forecasting. As such, the selection and pricing does not match specific, immediately available serving opportunities and advertisement inventory. Methods are provided which are in some ways analogous to providing futures—like mini-contracts on an advertising exchange, in which selection and pricing are decoupled from fulfillment of the mini-contracts in the form of serving of advertisements. This can allow auction format advantages while yet allowing forecasting, offline processing and relatively inexpensive operation costs.

### BACKGROUND

An online advertising exchange may facilitate matching of advertisement serving opportunities with advertising inventory, and serving of advertisements accordingly. Such an exchange may connect parties including advertisers, publishers, and networks thereof. Targeting and other criteria and requirements for advertisement selection and matching may be obtained or supplied by parties including advertisers.

A spot market auction format may be used for real-time or spot market matching and pricing, which may include determination of ranking, of particular advertisements with particular serving opportunities, leading to serving and impressions. Matching and determinations are made with particularity, and pricing can be determined with great specificity.

However, on a large scale, spot market auction formats can be extremely complex, expensive, and difficult to manage and operate. Operation, management, and optimization must be accomplished across many different advertisers, networks and publishers. Furthermore, selection and matching must be performed in connection with huge numbers of serving opportunities and advertisements and the associated targeting, budgetary and other criteria and requirements. With the nearly immediate timing required for a spot market auction format, where offline calculations may be impossible, and here particular serving opportunities are immediately matched with available advertising inventory, this can present an extremely difficult problem. As such, the agility, specificity, and particularity of the spot market auction format are unfortunately necessarily matched with the extremely difficult problem of operation, management, and optimization under extremely tight timing parameters.

Guaranteed delivery agreements or contracts in many ways stand in contrast with spot market auction format. With such contracts, for example, advertisers may be provided with a guarantee of a certain number of impressions being provided, in accordance with specified targeting or other criteria, and at an agreed upon package price, to be delivered over a certain time period. Since such contracts cal be arranged well ahead of time, they provide many advantages in terms of planning and practicality over the spot market auction format.

However, with guaranteed delivery or other contracts formed in advance, the ability to forecast with any precision, such as forecasting available serving opportunities, etc., is extremely limited or impossible. As such, the terms of the contract, such as what is guaranteed and pricing, is difficult to determine with a high degree of accuracy, since market conditions and available inventory cannot be accurately forecasted so far in advance. As such, the guarantor may take on substantial risk, because market conditions may not accommodate fulfillment of the contract, or optimal fulfillment.

There is a need for improved techniques for use in managing online advertising, such as in connection with an online advertising exchange.

### SUMMARY

Some embodiments of the invention provide systems and methods for use in operating an online advertising exchange. In some embodiments, an auction format is utilized. Ho ever, generally, selection and pricing is rate-based, in that it does not match particular, specific, immediately available serving opportunities with advertisement inventory, as with a spot market auction format. Instead, near-term forecasting, such as on the order of minutes, is utilized to predict available inventory, perform selection, and determine pricing, such as for anticipated or forecasted impressions. As such, many of the advantages of a spot market auction format are provided, in terms of granularity, accuracy, precision, and optimization. However, many of the advantages of a typical guaranteed delivery contract rate-based format are also provided, including allowing forecasting, offline processing and calculations, greater practicality, and less expensive processing and operation costs.

### BRIEF DESCRIPTION OF THE DRAWINGS

FIG. 1 is a distributed computer system according to one embodiment of the invention;

FIG. 2 is a diagram of a method according to one embodiment of the invention;

FIG. 3 is a flow diagram of a method according to one embodiment of the invention;

FIG. 4 is a conceptual block diagram illustrating one embodiment of the invention; and

FIG. 5 is a flow diagram of a method according to one embodiment of the invention.

While the invention is described with reference to the above drawings, the drawings are intended to be illustrative, and the invention contemplates other embodiments within the spirit of the invention.

### DETAILED DESCRIPTION

Some embodiments of the invention provide systems and methods for use in operating an online advertising exchange. Some embodiments allow any of the advantages of a spot market auction format while also allowing many of the advantages of rate-based format. In some embodiments, an auction format is utilized. However, selection and pricing is rate-based, in that it does not match particular, specific, immediately available serving opportunities with advertisement inventory. Instead, near-term forecasting, such as on the order of minutes, is utilized to predict available inventory, perform anticipated selection, and determine pricing, such as for particular anticipated or forecasted impressions. This process may be continually repeated, for example, at every server inventory update. In some embodiments, this process can be thought of as providing futures-like mini-contracts on the exchange, to be fulfilled in the near-term future.

Various embodiments of the invention can be used in different types of advertising and exchanges, including graphical or banner advertising, as ell as keyword-based advertising or sponsored search, including ranking of advertisements, etc. Many different forms of advertising are contemplated, including video, audio, content, indirect advertising content, etc. While described in connection with impressions, other metrics or performance parameters may be involved instead or in addition to impressions.

Some embodiments allow many of the advantages of an auction format, including the ability to handle complex advertiser bidding language expressions, such as Boolean expressions, including “or” terms, branching terms, and other complex expressions. These can include, for example, expressions in which more than one set of parameters are provided, where any of the sets of parameters can be satisfied, perhaps within specific constraints or conditions, to allow serving of an acceptable impression. These can be considered alternative sets of parameters. Other complex or Boolean expressions are also possible and many can be accommodated by the auction format used in some embodiments of the invention.

Each set of parameters can include multiple particular parameters. Advertisement parameters may specify, for example, an advertisement or group of advertisements. Targeting parameters may specify, for example, acceptable user groups or criteria, acceptable publishers or publisher sites, etc. Bidding parameters can specify, for example, amounts or ranges of amounts that an advertiser is willing to pay for certain impressions or impressions satisfying certain criteria, etc. Of course, other types of parameters may also be included, such as budgetary parameters.

For example, these can include multiple sets of parameters as alternative sets of requirements or acceptable parameters for advertisement serving.

Other advantages of an auction format according to embodiments of the invention can include allowing a high degree of marketplace optimization and highly accurate and precise advertisement selection and pricing, such as pricing of impressions.

In some embodiments, impressions in a non-guaranteed delivery exchange or format are in some ways viewed or treated as a stream of events occurring over a period of time, with associated probabilities. Forecasting can be performed, and probabilities determined or estimated, with regard to particular possibilities or occurrences of events of interest. Forecasting can use various techniques known in the art, including machine learning and clustering algorithms. Based on such forecasting, current selection and pricing can be performed for future serving of on an impression considered or determined to be an equivalent, or sufficiently equivalent, impression. The definition of equivalence, or sufficient equivalence, can of course vary. However, generally, equivalence is measured in connection with the targeting profile represented by the query issued with the initial advertising call. Equivalence can also be associated with, for example, user groups or user or audience characteristics, profiles, or archetypes, or to specific publishers or publisher sites.

In some embodiments, for some percentage of impressions, it may not be possible to establish equivalency, or a sufficient degree of equivalency. Such impressions may be handled, for example, by being left to a real-time auction for handling and serving.

With a non-guaranteed exchange, a graph representation may be used to represent or model relationships, parameters or constraints associated with or imposed by advertisers, networks, publishers, etc. In a real-time spot market auction, a path optimization may be performed with regard to this model in order to identify an available creative that matches a particular impression. However, this problem is extremely difficult to solve or manage, especially in the tiny amount of time, perhaps a small fraction of a second, which may be available for real-time processing.

Some embodiments of the invention make selection and pricing much easier by decoupling selection and pricing from serving, where serving can include, for example, serving the winning advertisement for an impression. By doing so, processing and calculation relating to such selection and pricing can be performed over a longer period of time, generally on the order of minutes, and can be performed offline. This, in turn, leads to much greater efficiency and optimization, and is much less expensive to operate.

Additionally, in some embodiments, advertisement selection and matching is performed in connection with a complex advertising exchange. Such an exchange can include not just a single network, but in fact many networks, such that the exchange can be or include essentially a network of networks. With such a complex exchange, optimal advertisement selection can involve path optimization within or through the exchange, including through intermediary networks. Conditions within the exchange can change rapidly, however, so that paths can rapidly change, or the graph, as mentioned above, can change, and a determined path can become invalid in a short period of time. To deal with this, a typical guaranteed delivery mechanism, as discussed above, would require forecasting well in advance, and as such would encounter difficulty or inefficiency in attempting to anticipate, forecast, otherwise cope with path or graph changes. In embodiments of the present invention, however, the advertisement selection and matching process and the serving process, while advantageously decoupled, are separated by a short time frame. This short separation time frame minimizes path changes and the need to forecast and deal with them, thus enhancing efficiency while preserving a rate-based mechanism.

In some embodiments, selection can include determining an optimal or sufficiently optimal path in the graph model associated with the exchange. With some systems, it is assumed that selection of such an optimal path must result in serving of the particular impression corresponding to the ad call, which means a real-time auction in which impressions are effectively perishable goods. In some embodiments, many important advantages are realized or made possible by decoupling the selection and pricing processes from the serving process.

As such, in some embodiments, optimal path selection can be viewed as pinpointing a winning advertisement and setting its price for a future serving of an equivalent impression, based on a current ad call, thus decoupling selection and pricing from serving. Repetition of this process over time can be used in determining a delivery plan for pre-purchased impressions that can implemented by server computers. Such pre-purchased impressions can be considered analogous to mini-contracts or allocations, or futures as the term is used in investing. In some embodiments, such mini-contracts can represent an obligation, associated with the exchange, to serve an specified advertisement, for a price determined during an auction phase, on a future impression considered equivalent based on an impression corresponding to one at the time of purchase, within a certain time window, generally on the order of minutes.

In some embodiments, this decoupling can allow guaranteed delivery and non-guaranteed delivery serving to be accomplished in an integrated or partially integrated fashion, and may allow or partially use of the same servers for serving.

In some embodiments, although selection and pricing are decoupled, little or nothing changes with regard to the experience and expectations of advertisers and publishers on the exchange relative to a real-time auction format. Advertisers' interests are served by obtaining appropriate impressions that match specified criteria, such as targeting, bidding, and budgetary criteria, and maximizing return on investment. Publishers' interests are served by maximizing and optimizing revenue within given constraints.

In some embodiments, steps are taken to ensure that data freshness and update frequency are maintained at sufficient levels to maintain a standard of accuracy, freshness, or fairness.

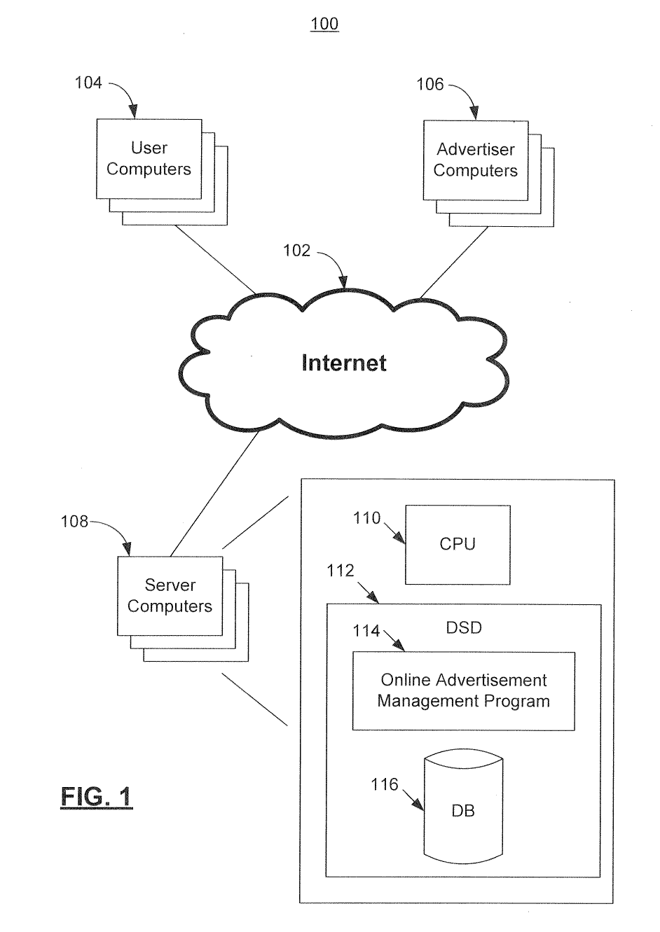

FIG. 1 is a distributed computer system 100 according to one embodiment of the invention. The system 100 includes user computers 104, advertiser computers 106 and server computers 108, all coupled or couplable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc. The invention further contemplates advertising in or using a variety of different media, systems, venues and networks, which can include, for example, advertising and networks in connection with gaming, interactive television, mobile devices such as cell phones, online or computerized adaptations based on print media, etc.

Each of the one or more computers 104, 106, 108 may be distributed, and can include various hardware, software, applications, programs and tools. Depicted computers and systems can include spinning or solid state disks for persistent storage memory, as well various networking hardware, software and peripherals, such as network interface cards, etc. Depicted computers may also include a hard drive, monitor, keyboard, pointing or selecting device, etc. The computers may operate using an operating system such as Linux, Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context.

As depicted, each of the server computers 108 includes one or more CPUs 110 and a data storage device 112. The data storage device 112 includes a database 116 and an online advertisement management program 114.

The online advertisement management program 4 is intended to broadly include all programming, applications, software and other and tools necessary to implement or facilitate methods and systems according to embodiments of the invention, whether on a single server computer or distributed among multiple computers or devices.

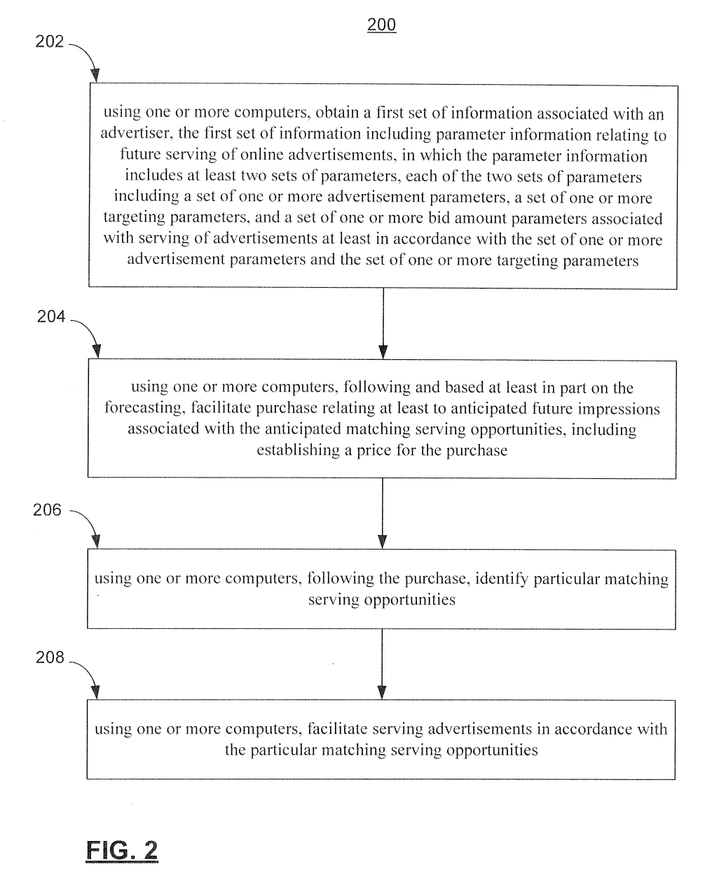

FIG. 2 is a flow diagram 200 of a method according to one embodiment of the invention, which may be implemented or facilitated, for example, using the online advertisement management program 114 and the database 116.

At step 202, using one or more computers, a first set of information associated with an advertiser is obtained, the first set of information comprising parameter information relating to future serving of online advertisements. The parameter information includes at least two sets of parameters. Each of the at least two sets of parameters includes a set of one or more advertisement parameters, a set of one or more targeting parameters, and a set of one or more bid amount parameters associated with serving of advertisements at least in accordance with the set of one or more advertisement parameters and the set of one or more targeting parameters. The at least two sets of parameters, can be, for example, alternative sets of parameters, or sets of parameters connected in some other Boolean or logical way.

At step 204, using one or more computers, following and based at least in part on the forecasting, purchase is facilitated relating at least to anticipated future impressions associated with the anticipated matching serving opportunities, including establishing a price for the purchase.

At step 206, using one or more computers, following the purchase, particular matching serving opportunities are identified.

At step 208, using one or more computers, serving of advertisements is facilitated in accordance with the particular matching serving opportunities.

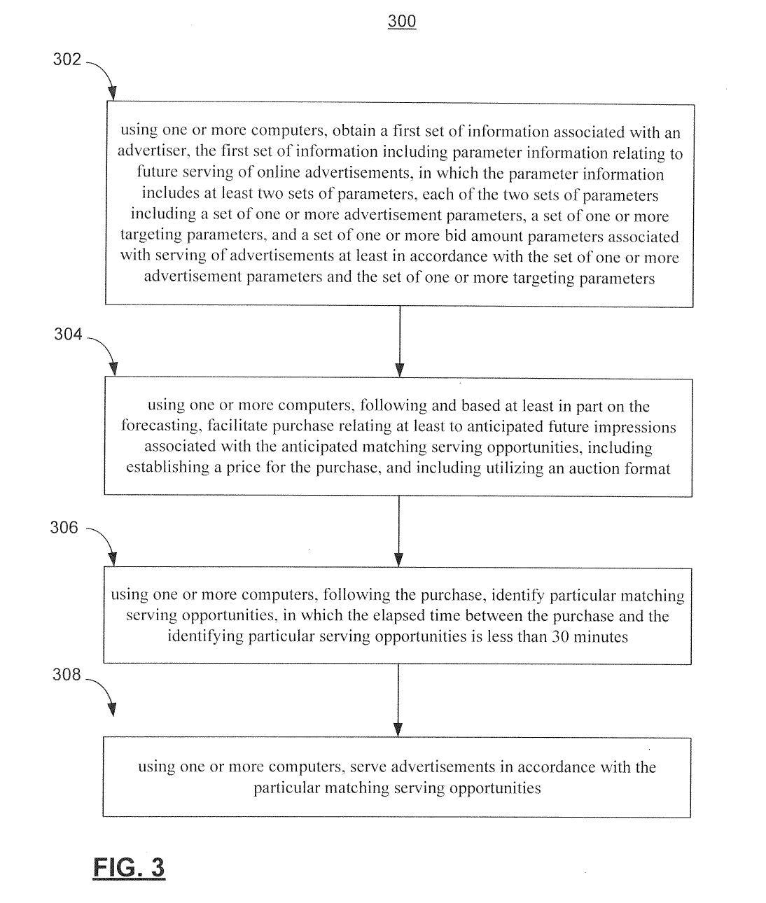

FIG. 3 is a flow diagram of a method 300 according to one embodiment of the invention.

Step 302 is similar to step 202 of FIG. 2.

At step 304, using one or more computers, following and based at least in part on the forecasting, purchase is facilitated relating to anticipated future impressions associated with the anticipated matching serving opportunities, including establishing a price for the purchase, and including utilizing an auction format.

At step 306, using one or more computers, following the purchase, particular matching serving opportunities are identified. The elapsed time between the purchase and the identifying particular serving opportunities is less than 30 minutes. In other embodiments, this time can vary.

At step 308, using one or more computers, advertisements are served in accordance with the particular matching serving opportunities.

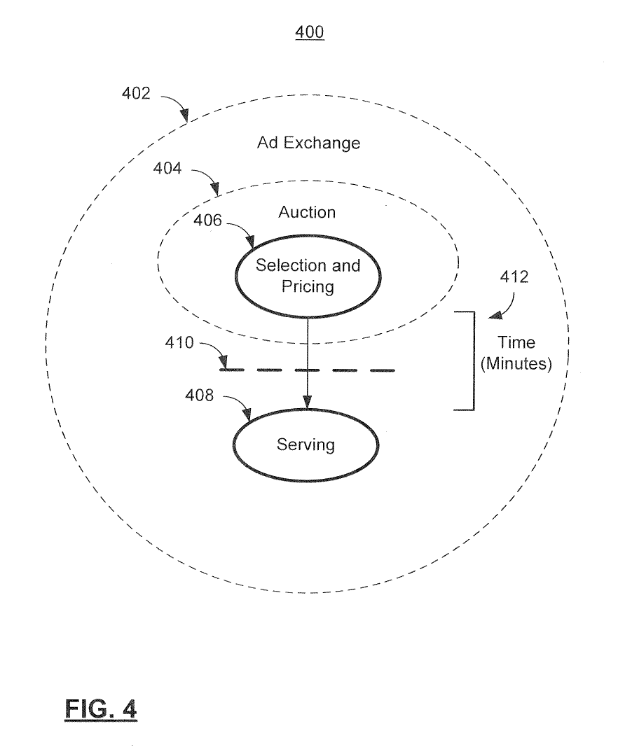

FIG. 4 is a conceptual block diagram 400 illustrating one embodiment of the invention. Dotted circle 402 represents the online advertising exchange. Dotted circle 404 represents an auction format utilized in the selection and pricing process, which can include managing advertise bidding and selection parameters, advertisement inventory, and serving opportunity inventory, which can be forecasted. Circle 406 represents selection and pricing according some embodiments of the invention, such as with respect to forecasted impressions or groups of impressions. Circle 408 represents serving of advertisements according to some embodiments of the invention, generally in accordance with planning or forecasting in the selection and pricing process.

Bracket 412 represents the time between the selection and pricing 406 and the serving 408. This amount of time can be on the order of minutes, such as 30 minutes, 15 minutes, 10 minutes, or even less. In some embodiments, this amount of time may correspond with or effected by time between server inventory updates or other exchange information refreshing or updating. Additionally, in some embodiments, auction processes, including the selection and pricing 406, may occur repeatedly and continually, and may occur each update.

Dotted line 410 represents the separation between and decoupling of the selection and pricing 406 and the serving 408, according to some embodiments of the invention. In some embodiments, while an auction format is utilized, as depicted by dotted circle 404, the selection and pricing 406 is none the less decoupled from the serving 408. As such, while advantages of an auction format are obtained, the decoupling of the selection and pricing 406 from the serving 408 allows many advantages not available with spot market auctions. These advantages can include forecasting, offline processing, greater practicality, and lower processing and operating costs relative to spot market auction formats.

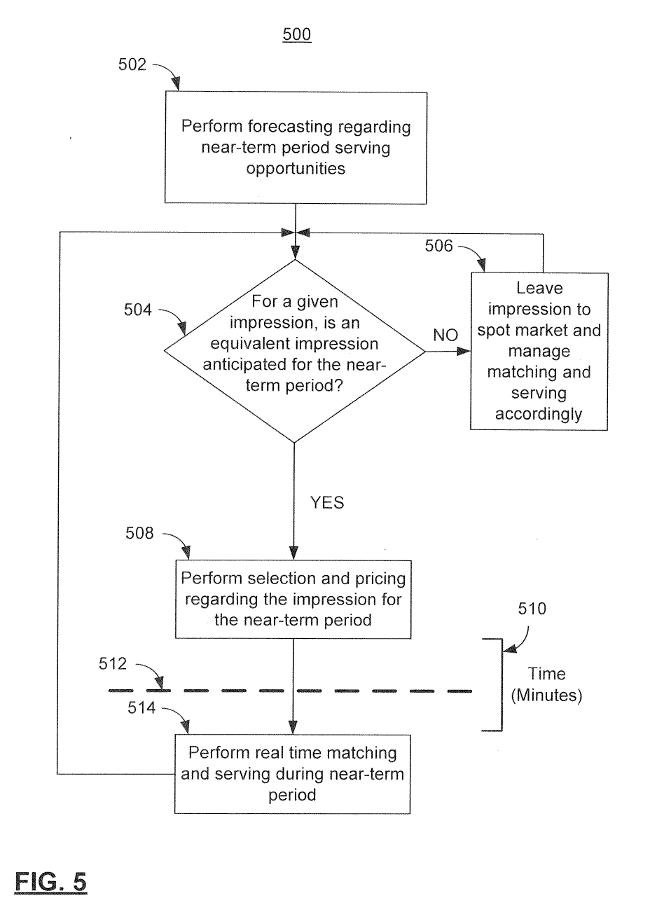

FIG. 5 is a simplified flow diagram of a method 500 according to one embodiment of the invention. While, for simplicity of description, processes in FIG. 5 are depicted with respect to individual impressions and separately performed, it is to be understood that, in some embodiments, such processes may be performed in a simultaneous or overlapping fashion, or with regard to groups of impressions or other features or performance parameters. Furthermore, it is to be understood that such processes may be or partially combined with other processes.

At step 502, forecasting is performed regarding near-term period serving opportunities. Forecasting may also be performed on other variables, such as advertising inventory. Machine learning, clustering, or other techniques may be used in such forecasting

At step 504, the method 500 queries whether, for a given impression, an equivalent impression is anticipated for the near term period.

If not, then the method proceeds to step 506, where the impression is left a spot market auction, and matching and serving is managed accordingly. The method 500 then returns to step 504, with regard to another impression. As mentioned above, method 500 is simplified, and some embodiments or the invention do not necessarily process impressions serially or separately.

If so, then the method 500 proceeds to step 508, here, for the impression, selection and pricing is performed regarding the impression, for the near-term period. The method 500 then returns to step 504 with regard to another impression. As mentioned above, method 500 is simplified, and some embodiments or the invention do not necessarily process impressions serially or separately.

Following step 508, at step 514, real time matching and serving are performed during the near-term period, after which the method 500 returns to step 504, with regard to another impression.

Ad represented by dotted line 512, the time between step 508 and step 514 can be on the order of minutes.

The foregoing description is intended merely to be illustrative, and other embodiments are contemplated within the spirit of the invention.

1. A method relating to operating an online advertisement exchange, comprising:
using one or more computers, obtaining a first set of information associated with an advertiser, the first set of information comprising parameter information relating to future serving of online advertisements,
wherein the parameter information comprises at least two sets of parameters, each of the at least two sets of parameters comprising:
a set of one or more advertisement parameters;
a set of one or more targeting parameters; and
a set of one or more hid amount parameters associated with serving of advertisements at least in accordance with the set of one or more advertisement parameters and the set of one or more targeting parameters;
using one or more computers, forecasting availability of anticipated matching serving opportunities, wherein a matching serving opportunity is a serving opportunity that matches at least one of the at least two sets of parameters;
using one or more computers, following and based at least in part on the forecasting, facilitating purchase relating at least to anticipated future impressions associated with the anticipated match serving opportunities, including establishing a price for the purchase;
using one or more computers, following the purchase, identifying particular matching serving opportunities; and
using one or more computers, facilitating serving of advertisements in accordance with the particular matching serving opportunities.

2. The method of claim, herein obtaining the at least two sets of parameter information comprises obtaining at least two alternative sets of parameter information.

3. A system for use in an online advertising exchange, comprising:
one or more server computers connected to the Internet; and
one or more databases connected to the one or more server computers;
wherein the one or more server computers are for:
obtaining a first set of information associated with an advertiser, the first set of information comprising parameter information relating to future serving of online advertisements,
wherein the parameter information comprises at least two sets of parameters, each of the at least two sets of parameters comprising;
a set of one or more advertisement parameters;
a set of one or more targeting parameters; and
a set of one or more hid amount parameters associated with serving of advertisements at least in accordance with the set of one or more advertisement parameters and the set of one or more targeting parameters;
forecasting availability of anticipated matching serving opportunities, wherein a matching serving opportunity is a serving opportunity that matches at least one of the at least two sets of parameters;
following and based at least in part on the forecasting, facilitating purchase relating at least to anticipated future impressions associated with the anticipated matching serving opportunities, including establishing a price for the purchase;
following the purchase, identifying particular matching serving opportunities; and using one or more computers, facilitating serving of advertisements in accordance with the particular matching serving opportunities; and
facilitating serving of advertisements in accordance with the particular matching serving opportunities.

4. The system of claim 3, wherein the elapsed time between the purchase and the identifying particular matching serving opportunities is less than 30 minutes.

5. The system of claim 3, wherein serving relates to impressions determined to be equivalent or sufficiently equivalent to impressions that would be associated with an ad call occurring during an auction phase.

6. The system of claim 3, wherein the one or more server computers are further for obtaining at least two alternative sets of parameter information.

7. The system of claim 3, wherein, based at least in part on the forecasting, some purchases are deferred to a spot market auction.

8. The system of claim 3, wherein the one or more server computers are further for serving of advertisements in accordance with the particular matching serving opportunities.

9. The system of claim 3, wherein the forecasting utilizes offline computation.

10. The system of claim 3, wherein the system is rate-based and does not include purchasing relating to particular individual impressions or serving opportunities.

11. The system of claim 3, wherein the system utilizes an auction format relating to purchasing of impressions by advertisers.

12. The system of claim 3, wherein the forecasting utilizes a machine learning technique.

13. The system of claim 3, wherein the forecasting utilizes probabilistic techniques.

14. The system of claim 3, wherein the purchase relates to impressions as futures.

15. The system of claim 3, wherein the forecasting utilizes historical advertisement performance information relating to a plurality of advertising campaigns.

16. The system of claim 3, wherein the purchase in a non-guaranteed delivery purchase.

17. The system of claim 3, wherein the one or more advertisement parameters identify one or more advertisements or groups of advertisements.

18. The system of claim 3, wherein the targeting parameters identify criteria including specific user characteristics.

19. The system of claim 3, wherein the one or more server computers are further for optimizing serving in connection with a plurality of simultaneously active advertising campaigns.

20. A computer readable medium or media containing instructions for executing a method, the method comprising:
using one or more computers, obtaining a first set of information associated with an advertiser, the first set of information comprising parameter information relating to future serving of online advertisements,
wherein the parameter information comprises at least two sets of parameters, each of the at least two sets of parameters comprising:
a set of one or more advertisement parameters;
a set of one or more targeting parameters; and
a set of one or more bid amount parameters associated with serving of advertisements at least in accordance with the set of one or more advertisement parameters and the set of one or more targeting parameters;
using one or more computers, forecasting availability of anticipated matching serving opportunities, wherein a matching serving opportunity is a serving opportunity that matches at least one of the at least two sets of parameters;
using one or more computers, following and based at least in part on the forecasting, implementing purchase relating at least to anticipated future impressions associated with the anticipated matching serving opportunities, including establishing a price for the purchase, and including utilizing an auction format;
using one or more computers, following the purchase, identifying particular matching serving opportunities,
wherein the elapsed time between the purchase and the identifying particular matching serving opportunities is less than 30 minutes; and
using one or more computers, serving advertisements in accordance with the particular matching serving opportunities.
